(19) United States
(12) Patent Application Publication
(10) Pub. No.: US 2025/0389896 A1
(43) Pub. Date: Dec. 25, 2025

(54) POLARIZATION CONTROL AND RELATED PHOTONIC INTEGRATED CIRCUITS

(71) Applicant: General Dynamics Mission Systems, Inc., Fairfax, VA (US)

(72) Inventors: Bhaskar S. Abhiraman, Morristown, NJ (US); David L.K. Eng, Fairport, NY (US)

(73) Assignee: General Dynamics Mission Systems, Inc., Fairfax, VA (US)

(21) Appl. No.: 18/752,376

(22) Filed: Jun. 24, 2024

(51) Int. Cl. G02B 6/27; G02B 6/122; G02B 6/42

(52) U.S. Cl. CPC G02B 6/2773; G02B 6/1228; G02B 6/4213

(57) ABSTRACT

Apparatus are provided for photonic integrated circuits or other optical devices. An exemplary photonic integrated circuit (PIC) includes a polarization splitting arrangement to split an optical signal into a first portion having a first polarization and a second portion having a second polarization orthogonal to the first polarization, a signal conditioning arrangement to balance magnitudes of the respective signals, a polarization shifting arrangement coupled to the signal conditioning arrangement to provide a adjusted signals based on the respective signals and a difference between a first relationship between the respective signals and a targeted relationship corresponding to a targeted state of polarization, and an output polarization combining arrangement coupled to the polarization shifting arrangement and configured to provide an output optical signal representing a combination of the respective signals.

### TECHNICAL FIELD OF THE INVENTION

The subject matter described herein relates generally to optical communications systems, and more particularly, embodiments of the subject matter relate to optical devices with arbitrary-to-arbitrary polarization control.

### BACKGROUND OF THE INVENTION

This section provides background information related to the present disclosure which is not necessarily prior art.

Optical telecommunication systems typically include discrete components that perform various optical functions, such as, for example, modulation, demodulation, multiplexing, demultiplexing, and the like. Photonic integrated circuits (PICs) have been developed that incorporate optical components, such as waveguides, filters and the like, into a packaged optical or electro-optical devices or chip, rather than reliance on larger discrete fiber optic components. This allows for more complex optical or electro-optical systems to be packaged into a smaller form factor to suit a variety of different applications. However, various components of PICs can be sensitive to state of polarization, which may fluctuate depending on environmental conditions or system dynamics. Additionally, in fiberoptic systems or other telecommunications applications, polarization multiplexed signals present additional complexity since rotation of orthogonal constituent signals can impair the ability of signals to be properly demultiplexed. Accordingly, it is desirable to be able to control the state of polarization of signals entering or exiting a PIC or at other locations within optical systems to help ensure proper operation. Other desirable features and characteristics will become apparent from the subsequent detailed description and the appended claims, taken in conjunction with the accompanying drawings and the foregoing technical field and background.

### SUMMARY OF THE INVENTION

This section provides a general summary of the disclosure and is not a comprehensive disclosure of its full scope or all of its features.

Apparatus are provided for photonic integrated circuits or other optical devices.

An exemplary photonic integrated circuit (PIC) includes an input polarization splitting arrangement to split an input optical signal into a first portion at a first output and a second portion at a second output, wherein the first portion represents a first polarization orthogonal to a second polarization of the second portion, a signal conditioning arrangement coupled to the first output and the second output of the input polarization splitting arrangement to provide a first signal corresponding to the first portion of the input optical signal and a second signal corresponding to the second portion of the input optical signal, wherein the signal conditioning arrangement is configurable to balance a first magnitude of the first signal and a second magnitude of the second signal, a polarization shifting arrangement coupled to the signal conditioning arrangement to provide a first adjusted signal and a second adjusted signal based on the first signal, the second signal and a difference between a first relationship between the first signal and the second signal and a targeted relationship corresponding to a targeted state of polarization, and an output polarization combining arrangement coupled to the polarization shifting arrangement and configured to provide an output optical signal representing a combination of the first adjusted signal and the second adjusted signal.

An exemplary a polarization control system is provided that includes a first polarization splitter-rotator to receive an input optical signal and split the input optical signal into a first input signal representing a transverse electric polarization of the input optical signal and a second input signal representing a transverse magnetic polarization of the input optical signal orthogonal to the transverse electric polarization, a signal conditioning arrangement coupled to the first polarization splitter-rotator configurable to receive the first input signal and the second input signal and generate a first power balanced signal corresponding to the transverse electric polarization of the input optical signal and a second power balanced signal corresponding to the transverse magnetic polarization of the input optical signal by regulating a first magnitude of the first input signal to a second magnitude of the second input signal, a polarization shifting arrangement coupled to the signal conditioning arrangement to provide a first adjusted signal and a second adjusted signal based on the first power balanced signal, the second power balanced signal and a difference between a relationship between the first power balanced signal and the second power balanced signal and a targeted state of polarization, and an output polarization combiner configurable to provide an output optical signal having the targeted state of polarization, wherein the output optical signal represents a combination of the first adjusted signal and the second adjusted signal.

An exemplary method of transforming an input optical signal to an output optical signal having a targeted state of polarization using a PIC is also provided. The method involves splitting the input optical signal into a first input signal representing a transverse electric polarization of the input optical signal and a second input signal representing a transverse magnetic polarization of the input optical signal orthogonal to the transverse electric polarization, generating a first power balanced signal representing the transverse electric polarization and a second power balanced signal representing the transverse magnetic polarization based on the first input signal and the second input signal by adjusting a phase of at least one of the first input signal and the second input signal and interferometrically mixing them with a 50/50 coupler, obtaining, using a polarimeter associated with the PIC, measurement data indicative of a state of polarization of a combination of a first output signal corresponding to the transverse electric polarization and a second output signal corresponding to the transverse magnetic polarization, dynamically adjusting, based on the measurement data, the relative magnitude and phase of the first power balanced signal and the second power balanced signal to obtain the first output signal and the second output signal having a targeted magnitude and phase relationship based on a difference between the state of polarization and the targeted state of polarization, and combining the first output signal and the second output signal into the output optical signal having the targeted state of polarization.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, where corresponding reference numerals indicate corresponding parts throughout the several views of the drawings. The particular choice of drawings is not intended to limit the scope of the present disclosure.

FIG. 1 depicts a block diagram of an exemplary optical device in accordance with one or more exemplary implementations;

FIG. 2 depicts a schematic diagram of an exemplary polarization control circuit suitable for use in the optical device of FIG. 1 in accordance with one or more exemplary implementations;

FIG. 3 depicts a perspective view of an exemplary polarization splitter-rotator suitable for use in the polarization control circuit of FIG. 2 in accordance with one or more exemplary implementations;

FIG. 4 depicts a schematic diagram of an exemplary polarimeter suitable for use in the polarization control circuit of FIG. 2 in accordance with one or more exemplary implementations;

FIG. 5 depicts a block diagram of an exemplary signal conditioning control system suitable for use in the polarization control circuit of FIG. 2 in accordance with one or more exemplary implementations; and

FIG. 6 depicts a block diagram of an exemplary polarization control system suitable for use in the polarization control circuit of FIG. 2 in accordance with one or more exemplary implementations.

### DETAILED DESCRIPTION

The following detailed description is merely exemplary in nature and is not intended to limit the subject matter of the application and uses thereof. Furthermore, there is no intention to be bound by any expressed or implied theory presented in the preceding technical field, background, summary, or the following detailed description.

Embodiments of the subject matter described herein generally pertain to optical or electro-optical devices such as photonic integrated circuits (PICs) that include polarization controls capable of arbitrary-to-arbitrary polarization control. In this regard, polarization control circuitry may be configurable to span the Poincaré sphere under a range of input conditions by mapping, rotating or otherwise transforming the polarization state or phase of an input optical signal from any sort of fixed or arbitrary polarization to a desired polarization state at the output of the polarization control circuitry.

The polarization control circuitry includes an input polarization splitting arrangement that maps or splits orthogonal polarizations to different waveguides to provide a first optical signal representing a first portion of the input optical signal corresponding to a transverse electric (TE) polarization at a first output waveguide and a second optical signal representing a second portion of the input signal corresponding to a transverse magnetic (TM) polarization at a second output waveguide. An input signal conditioning arrangement is coupled to the respective waveguide outputs of the polarization splitting arrangement and includes one or more phase shifters and couplers that are operable to adjust the phase of the TE polarization signal portion and/or the TM polarization signal portion to interferometrically regulate (e.g., via constructive or destructive interference) the respective magnitudes of the respective signal portions to be substantially equal to one another.

A polarization shifting arrangement is coupled to the signal conditioning arrangement and is configurable to generate or otherwise provide a phase adjusted TE polarization output signal based on the power balanced TE polarization signal exiting the signal conditioning arrangement and a relationship between a phase of the TE polarization signal and a second phase of the TM polarization signal exiting the signal conditioning arrangement. In this regard, the polarization shifting arrangement adjusts the phase of the power balanced TE polarization signal exiting the signal conditioning arrangement based on a difference between a relationship between the phase of the TE polarization signal and the phase of the TM polarization signal and a targeted phase relationship to regulate the phase of the phase adjusted TE polarization output signal to a targeted relationship with respect to the phase of the TM polarization signal, which corresponds to a desired polarization control of the output optical signal exiting the polarization control circuitry. In this regard, when the signal conditioning outputs substantially equal TE and TM powers, this downstream polarization shifting arrangement may achieve any desired magnitude and phase relationship between the TE and TM signals (e.g., using phase shifters and 50/50 couplers similar to the signal conditioning arrangement) that corresponds to a desired polarization control of the output optical signal exiting the polarization control circuitry.

Downstream of the polarization shifting arrangement, an output polarization combiner recombines the signals having the desired magnitude and phase relationship between the TE and TM signals and thereby outputs a combined signal having the desired polarization state. In this regard, by regulating the polarization magnitudes to be essentially balanced or a 50/50 split between the TE polarization signal portion and the TM polarization signal portion at the output of the signal conditioning arrangement, the downstream polarization shifting arrangement of the polarization control circuitry is capable of providing any arbitrary relative magnitude and phase between TE and TM polarizations, allowing the resulting output of the polarization control circuitry to span the Poincaré sphere.

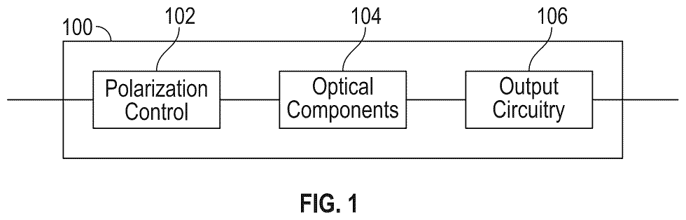

FIG. 1 depicts an exemplary optical device 100 that includes a polarization control circuitry 102 coupled between an input interface of the optical device 100 and one or more downstream optical components 104 to control the state of polarization of the input optical signal received at the input interface of the optical device 100 based on the desired or targeted polarization for the downstream optical components 104. In this regard, the downstream optical components 104 may be realized as one or more filters, multiplexers, demultiplexers and/or the like that are sensitive to the polarization of an input optical signal, where the polarization control circuitry 102 regulates the state of polarization of the input optical signals received at the input interface to the particular state of polarization that is desired or expected for proper functioning of the downstream optical components 104. The processed optical signal output by the downstream optical components 104 may then be transmitted to through port circuitry 106, which generally represents the optical ports, couplers and/or other optical components of engaging with optical fibers for transmitting optical signals from the optical device 100. In exemplary implementations, the optical device 100 is realized as a photonic integrated circuit (PIC), where the polarization control circuitry 102, the optical components 104 and the through port circuitry 106 are fabricated, formed or otherwise disposed on a semiconductor substrate that is then overmolded or otherwise encapsulated into an integrated circuit device package. Accordingly, for purposes of explanation, but without limitation, the optical device 100 may alternatively be referred to herein as a PIC. It should be appreciated that FIG. 1 is a simplified representation of an optical device 100 for purposes of explanation and is not intended to be limiting.

In practice, the polarization control circuitry 102 may be coupled to an optical fiber (e.g., via an optical port, coupler or the like) to receive an input optical signal to the PIC 100 that includes one or more optical communications channels transmitted via the optical fiber. In this regard, optical communications channels may be multiplexed into the input optical signal using any suitable multiplexing technique or combination thereof, depending on the particular application and configuration. In such implementations, the downstream optical components 104 may include or otherwise be realized as a filter or demultiplexer capable of filtering or otherwise isolating a respective one of the optical communications channels and output that respective optical communications channel to the output circuitry 106. In practice, the filters, demultiplexers or other optical components 104 of the PIC 100 may be designed for a particular polarization, such that the polarization control circuitry 102 is configurable or otherwise operable to control the state of polarization of the input optical signal input to the PIC 100 and provide an output optical signal to a downstream optical component 104 that has the targeted polarization for the optical component 104.

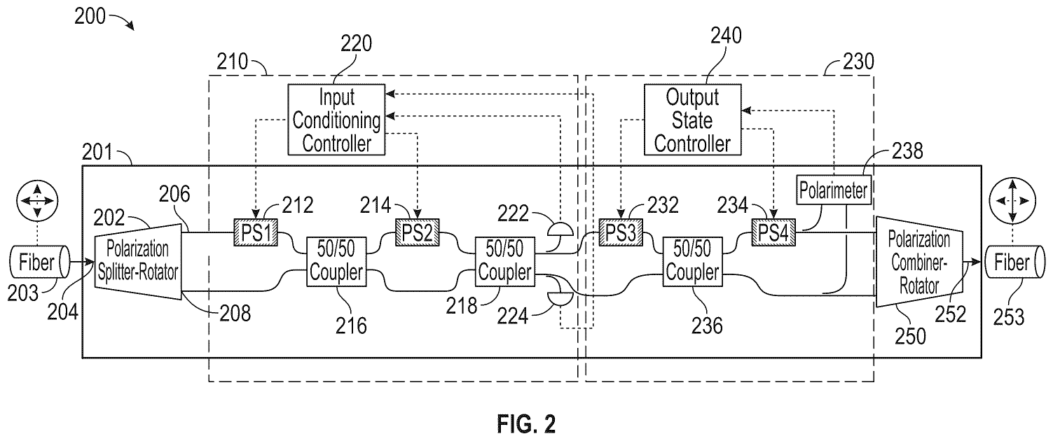

FIG. 2 depicts an exemplary implementation of a polarization control circuit 200 suitable for use as the polarization control circuitry 102 in the PIC 100 of FIG. 1. The polarization control circuit 200 includes an input polarization splitting arrangement 202 (or input polarization splitter-rotator), an input signal conditioning arrangement 210, a polarization shifting arrangement 230, and an output polarization combining arrangement 250 (or output polarization combiner-rotator) that may be fabricated on a semiconductor substrate 201 (or die) and encapsulated to provide an integrated circuit device package or PIC. The input polarization splitting arrangement 202 has an input 204 coupled to an optical port or fiber to receive an input optical signal and split the input optical signal into a first output signal at a first output 206 representing the TE polarized portion of the input optical signal and a second output signal at a second output 208 representing the TM polarized portion of the input optical signal orthogonal to the TE polarized portion.

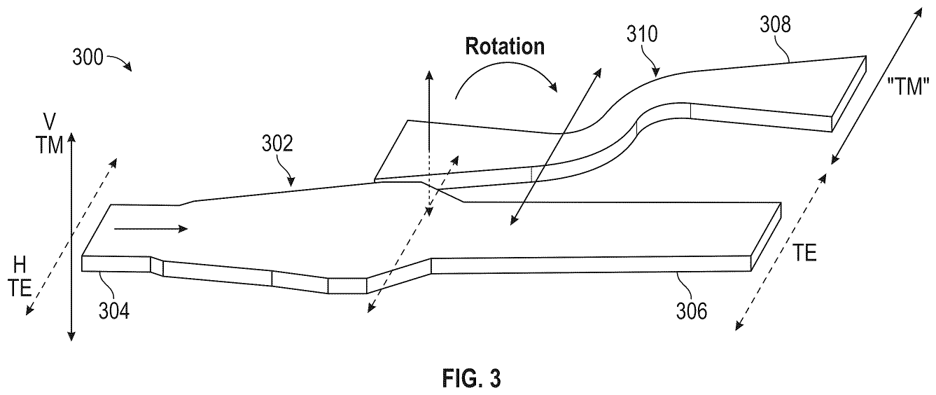

FIG. 3 depicts an exemplary polarization splitter-rotator 300 suitable for use as the input polarization splitting arrangement 202. The polarization splitter-rotator 300 includes a first waveguide 302 having an input 304 (e.g., input 204) for receiving the input optical signal and an output 306 (e.g., output 206) for transmitting or otherwise outputting the TE polarized portion of the input optical signal. In this regard, a second waveguide 310 includes an input end optically coupled to the first waveguide 302 between the respective input and output ends 304, 306 of the first waveguide 302 for coupling and thereby splitting the TM polarized portion from the input optical signal, resulting in only the TE polarized portion being transmitted to the first waveguide output 306. The second waveguide 310 geometry is further configured to rotate the TM polarized portion of the input optical signal to the TE polarization for purposes of further processing by the PIC 100. In this regard, the resulting optical signal transmitted at the output 308 (e.g., output 208) of the second waveguide 310 represents the portion of the input optical signal having the TM polarization rotated into the TE polarization. That said, for purposes of explanation, the portion of the input optical signal transmitted at the output 208, 308 of the input polarization splitting arrangement 202 may alternatively be referred to as the TM polarized portion of the input optical signal, even though it may be rotated to the TE polarization for purposes of processing by the PIC 100 within the polarization control circuitry 102.

Referring again to FIG. 2, the polarization control circuit 200 includes a signal conditioning arrangement 210 coupled to the outputs 206, 208 of the input polarization splitting arrangement 202. The signal conditioning arrangement 210 manipulates the relative magnitudes of the TE and TM polarized portions of the input optical signal to be substantially equal to achieve power balance and emulate an input optical signal having an even or balanced distribution of polarization. In this regard, the signal conditioning arrangement 210 includes one or more phase shifters 212, 214 that are inline with the optical path for the TE polarized portion of the input optical signal to manipulate the relative phase of the TE polarized portion and one or more 50/50 couplers 216, 218 that are inline with the optical paths of both the TE and TM polarized portions of the input optical signal to facilitate the signal conditioning arrangement 210 regulating the magnitude of an output signal representative of the TE polarized portion of the input optical signal to the magnitude of a second output signal representative of the TM polarized portion of the input optical signal that is output by the signal conditioning arrangement 210. In exemplary implementations, the 50/50 couplers 216, 218 are realized as multi-mode interferometers (MMI) or adiabatic couplers that split and combine the optical power in a substantially equal or 50/50 manner.

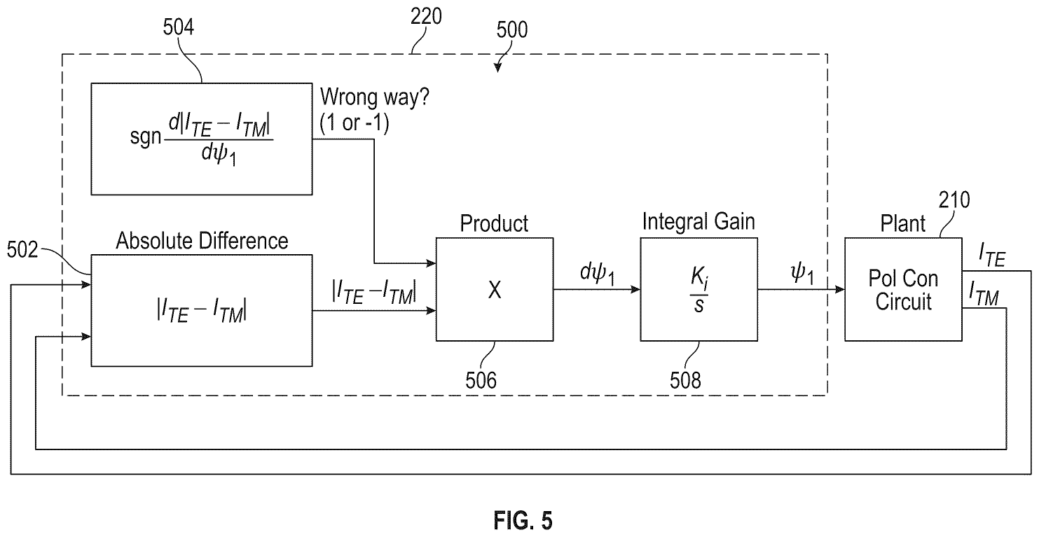

In exemplary implementations, the phase shifters 212, 214 are realized as thermo-optic phase shifters that are actuatable or otherwise operable by an input signal conditioning controller 220 to adjust the phase of the TE polarized portion of the input optical signal based on measurement feedback received via photodetectors 222, 224 that are optically coupled to the respective TE and TM optical paths via respective tap waveguides. In this regard, based on the measured amplitude of the TE polarized portion provided by the first photodetector 222 relative to the measured amplitude of the TM polarized portion provided by the second photodetector 224, the input signal conditioning controller 220 actuates, activates or otherwise operates the phase shifters 212, 214 to interferometrically balance the amplitudes measured by the photodetectors 222, 224, as described in greater detail below in the context of FIG. 5. As a result, the signal conditioning arrangement 210 provides a first output signal via the TE polarization optical path that represents the TE polarized portion of the input optical signal (e.g., the TE polarization output signal) and a second output signal via the TM polarization optical path that represents the TM polarized portion of the input optical signal (e.g., the TM polarization output signal) and regulates the magnitude of the TE polarization output signal to the magnitude of the TM polarization output signal to achieve a 50/50 power balance.

Still referring to FIG. 2, the polarization control circuit 200 further includes a polarization shifting arrangement 230 coupled to the outputs of the signal conditioning arrangement 210 to receive the power balanced TE and TM polarized portions of the input optical signal. The polarization shifting arrangement 230 generates or otherwise provides a desired relative magnitude and phase of the TE and TM signals corresponding to a targeted polarization for the optical signal to be output by the polarization control circuit 200. The polarization shifting arrangement 230 includes one or more phase shifters 232, 234 that are inline with the optical path for the TE polarized portion to manipulate the relative phase of the power balanced inputs and a 50/50 coupler 236 inline with the optical paths of both the TE and TM polarized signals, which allows phase shifts to interferometrically induce magnitude shifts. The phase shifters 232, 234 are actuatable or otherwise operable by an electronic output controller 240 to adjust the relative phase of the TE polarized portion and achieve the targeted magnitude and phase relationship between the TE and TM polarized signals after power balancing based on measurement feedback received via a polarimeter 238 that is optically coupled to the respective TE and TM optical paths via respective tap waveguides and provides measurements indicative of the state of polarization at the output of the polarization control circuit 200.

An output polarization combining arrangement 250 is coupled to the respective outputs of the TE and TM optical paths of the polarization shifting arrangement 230 and configurable to combine the phase and magnitude-manipulated TE and TM signals into an output optical signal having a targeted polarization for the polarization control circuit 200. In this regard, the output polarization combining arrangement 250 may be realized as a polarization splitter-rotator (e.g., similar to the polarization splitter-rotator 300 of FIG. 3) that functions equivalently to the input polarization splitting arrangement 202 but is inverted or otherwise arranged in an opposite manner so as to rotate the TM polarization representative signal into a true TM polarized state before combining the TM polarized signal with the TE polarized signal to obtain an output optical signal having respective TE polarized and TM polarized components when exiting the polarization control circuit 200. For example, the output 252 of the polarization combining arrangement 250 may be realized as an end of a waveguide that is optically coupled to another waveguide that is configured to rotate the TM polarized component signal output from the TM optical path of the polarization shifting arrangement 230 back to TM polarization before combining the TM polarized optical signal from the TM optical path with the phase adjusted TE polarized optical signal output from the TE optical path of the polarization shifting arrangement 230 to arrive at recombined output optical signal at the output 252 having the targeted state of polarization. It should be noted that although FIG. 2 depicts the polarization control circuit 200 as a discrete component fabricated on a semiconductor substrate 201 where the output 252 is coupled to a fiberoptic cable 253, in practice, the output 252 of the polarization control circuit 200 may be coupled to a waveguide configurable to route or otherwise transmit the output optical signal having the targeted state of polarization to a downstream component of a common PIC including the polarization control circuit 200, such as one of more of the downstream components 104, 106 of the PIC 100 depicted and described above in the context of FIG. 1.

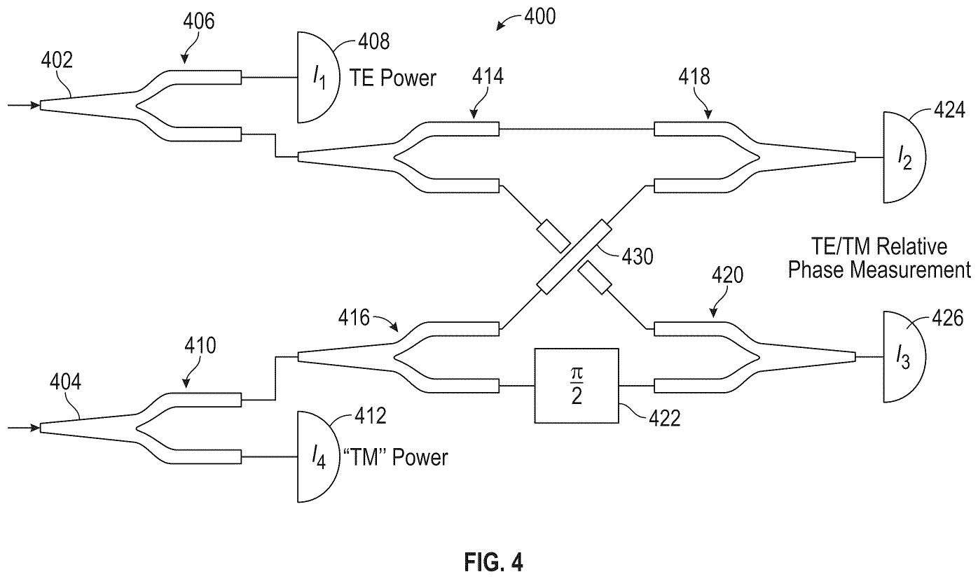

FIG. 4 depicts an exemplary polarimeter arrangement 400 suitable for use as the polarimeter 238 in the polarization shifting arrangement 230 of FIG. 2. Referring to FIG. 4, with continued reference to FIGS. 1-3, the polarimeter arrangement 400 provides state of polarization feedback measurement data to the electronic output controller 240 that is indicative of or otherwise reflects the magnitude and phase relationship between the TE and TM signals being combined into the output optical signal. The polarimeter arrangement 400 includes a pair of input waveguide taps 402, 404 that are optically coupled to the respective output optical paths of the polarization shifting arrangement 230 such that the TE input tap 402 receives a percentage (e.g., 10%) of the final TE signal and the TM input tap 404 receives substantially the same percentage of the TM signal. The TE input tap 402 is coupled to a respective input 50/50 splitter 406 having an output coupled to a first photodiode 408 configured to provide an output current measurement (11) indicative of the relative amplitude or power of the final TE signal. In a similar manner, the TM input tap 404 is coupled to a respective input 50/50 splitter 410 having an output coupled to another photodiode 412 configured to provide an output current measurement (14) indicative of the relative amplitude or power of the final TM signal.

The other outputs of the respective input splitters 406, 410 are input to a second set of 50/50 splitters 414, 416 that are arranged with a corresponding set of inverted 50/50 splitters 418, 420 with a 90° (or π/2 radian) phase delay component 422 in the TM optical path to provide an inner interferometer structure within the polarimeter arrangement 400. In this regard, an output of the TE path splitter 414 is combined with an output of the TM path splitter 416 via a combiner 418 (or inverted splitter) having a respective output that is coupled to another photodiode 424 to provide an output current measurement (I₂) indicative of the relative phase or interference between the phase adjusted TE polarized signal and the TM polarized signal. The other output of the TE path splitter 414 is combined with the other output of the TM path splitter 416 downstream of the phase delay component 422 via an inverted splitter 420 having a respective output that is coupled to another photodiode 426 to provide an output current measurement (I₃) indicative of the relative phase or interference between the phase adjusted TE polarized signal and the TM polarized signal with a 90° (or π/2) phase delay.

By virtue of the configuration of the polarimeter arrangement 400, the outer photodiodes 408, 412 measure the power (or amplitude) of the TE and TM polarization components directly, while the inner interferometer photodiodes 424, 426 measure the relative phase between the TE and TM polarization components by extracting the two quadrature amplitudes of the combined signal. Referring to FIG. 2, the outputs of the photodiodes 408, 412, 424, 426 are coupled to the output polarization controller 240 which is configurable to map a vector (\vec{I}) of the four measured photocurrents (I₁, I₂, I₃, I₄) provided by the photodiodes 408, 412, 424, 426 to a vector of four Stokes parameters \vec{S} by a 4×4 matrix: \vec{S}= [symbol] \vec{I}, where S₀ represents the total power of the signal and is equal to

$$\sqrt{{S}_{1}^{2} + {S}_{2}^{2} + {S}_{3}^{2}}$$

and [symbol] is a matrix for mapping the measured photocurrents to the surface of the Poincaré sphere while maintaining the ground truth pure TE and TM states.

Referring again to FIG. 2, the input signal conditioning controller 220 generally represents the hardware, software, and/or firmware components configured to support operation of the signal conditioning arrangement 210 and perform additional tasks and/or functions to support operation of the polarization control circuit 200 described herein. Depending on the embodiment, the input signal conditioning controller 220 may be implemented or realized with a general purpose processor, a content addressable memory, a digital signal processor, an application specific integrated circuit, a field programmable gate array, any suitable programmable logic device, discrete gate or transistor logic, processing core, discrete hardware components, or any combination thereof, designed to perform the functions described herein. It should be noted that although FIG. 2 depicts the input signal conditioning controller 220 as being implemented separate from or external to the semiconductor substrate 201, in practice, the input signal conditioning controller 220 may be fabricated on the semiconductor substrate 201 or otherwise integrated with a PIC including the polarization control circuitry 102, 200 (e.g., PIC 100).

In practice, the input signal conditioning controller 220 includes processing logic that may be configured to carry out the functions, techniques, and processing tasks associated with the operation of the polarization control circuit 200, as described in greater detail below. Furthermore, the steps of a method or algorithm described in connection with the embodiments disclosed herein may be embodied directly in hardware, in firmware, in a software module executed by the input signal conditioning controller 220, or in any practical combination thereof. For example, in one or more embodiments, the input signal conditioning controller 220 includes or otherwise accesses a data storage element (or memory), which may be realized as any sort of non-transitory short or long term storage media capable of storing programming instructions for execution by the input signal conditioning controller 220. The code or other computer-executable programming instructions, when read and executed by the input signal conditioning controller 220, cause the input signal conditioning controller 220 to support or otherwise perform certain tasks, operations, functions, and/or processes described herein.

FIG. 5 depicts an exemplary control diagram for a signal conditioning control system 500 suitable for implementation by the input signal conditioning controller 220 to dynamically adjust actuation of one or more phase shifters 212, 214 of an input signal conditioning arrangement 210 to regulate the amplitude or magnitude of the respective TE and TM component signals exiting the input signal conditioning arrangement 210 to achieve a desired power distribution, namely, a substantially equal or 50/50 distribution of power between the TE polarized component signal exiting the TE optical path and the TM polarized component signal exiting the TM optical path (e.g., by regulating the amplitude of the TE polarized component to the amplitude of the TM polarized component). The signal conditioning control system 500 includes an absolute difference determination component 502 configurable to calculate, determine or otherwise output a value indicative of the absolute value of the difference between the output measurement current from the TE path photodetector 222 (I_{TE}) indicative of the measured amplitude of the TE polarized component of the input optical signal and the output measurement current from the TM path photodetector 224 (I_{TM}) indicative of the measured amplitude of the TM polarized component of the input optical signal (e.g., |I_{TE}−I_{TM}|). The signal conditioning control system 500 also includes a directional difference determination component 504 configurable to calculate, determine or otherwise output an indication of whether the derivative or rate of change of the absolute value of the difference with respect to the change in actuation of the phase shifter(s) 212, 214 is in the correct direction. In this regard, since the input polarization state may be unknown, it is therefore unknown whether an increase or decrease in phase will correspondingly increase or decrease the difference (or power imbalance) between the TE and TM polarized components. Accordingly, the directional difference determination component 504 provides a positive or negative value (e.g., 1 or −1) that indicates the direction or manner in which the phase shifter(s) 212, 214 are to be actuated to reduce the power imbalance. The derivative of the absolute value of the difference with respect to the change in actuation of the phase shifter(s) 212, 214 can be calculated using the equation

$$\frac{d \vert {I}_{TE} - {I}_{TM} \vert}{d ψ} = \frac{d \vert {I}_{TE} - {I}_{TM} \vert}{dt} \div \frac{d ψ}{dt} .$$

In exemplary implementations, the input signal conditioning controller 220 is configurable as an integral controller that attempts to minimize the difference in magnitude between the respective TE and TM component signals in a closed-loop manner by including a phase adjustment determination component 506 that determines the rate at which to actuate and adjust the phase of the phase shifter(s) 212, 214 (dψ) based on a product of the absolute value of the difference output by the absolute difference determination component 502 and the respective sign or direction indicated by the directional difference determination component 504. The resulting phase adjustment rate (dψ) is input to an integral gain component 508 that provides a corresponding output indicative of the phase adjustment or setpoint (ψ) that is utilized by the input signal conditioning controller 220 to operate the phase shifter(s) 212, 214 of the input signal conditioning arrangement 210.

Referring again to FIG. 2, similar to the input signal conditioning controller 220, the output polarization controller 240 generally represents the hardware, software, and/or firmware components configured to support operation of the polarization shifting arrangement 230 and perform additional tasks and/or functions to support operation of the polarization control circuit 200 described herein, where depending on the embodiment, the output polarization controller 240 may be implemented or realized with a general purpose processor, a content addressable memory, a digital signal processor, an application specific integrated circuit, a field programmable gate array, any suitable programmable logic device, discrete gate or transistor logic, processing core, discrete hardware components, or any combination thereof. Although FIG. 2 depicts the output polarization controller 240 as being implemented separate from or external to the semiconductor substrate 201, in practice, the output polarization controller 240 may be fabricated on the semiconductor substrate 201 or otherwise integrated with a PIC including the polarization control circuitry 102, 200 (e.g., PIC 100). Additionally, although FIG. 2 depicts the input signal conditioning controller 220 and the output polarization controller 240 as separate and distinct components, in practice, they may be integrated or combined into a common processing component.

In practice, the output state controller 240 includes processing logic that may be configured to carry out the functions, techniques, and processing tasks associated with the operation of the polarization control circuit 200, as described in greater detail below. Furthermore, the steps of a method or algorithm described in connection with the embodiments disclosed herein may be embodied directly in hardware, in firmware, in a software module executed by the output polarization controller 240, or in any practical combination thereof. For example, in one or more embodiments, the output polarization controller 240 includes or otherwise accesses a data storage element (or memory), which may be realized as any sort of non-transitory short or long term storage media capable of storing programming instructions for execution by the output polarization controller 240. The code or other computer-executable programming instructions, when read and executed by the output polarization controller 240, cause the output polarization controller 240 to support or otherwise perform certain tasks, operations, functions, and/or processes described herein.

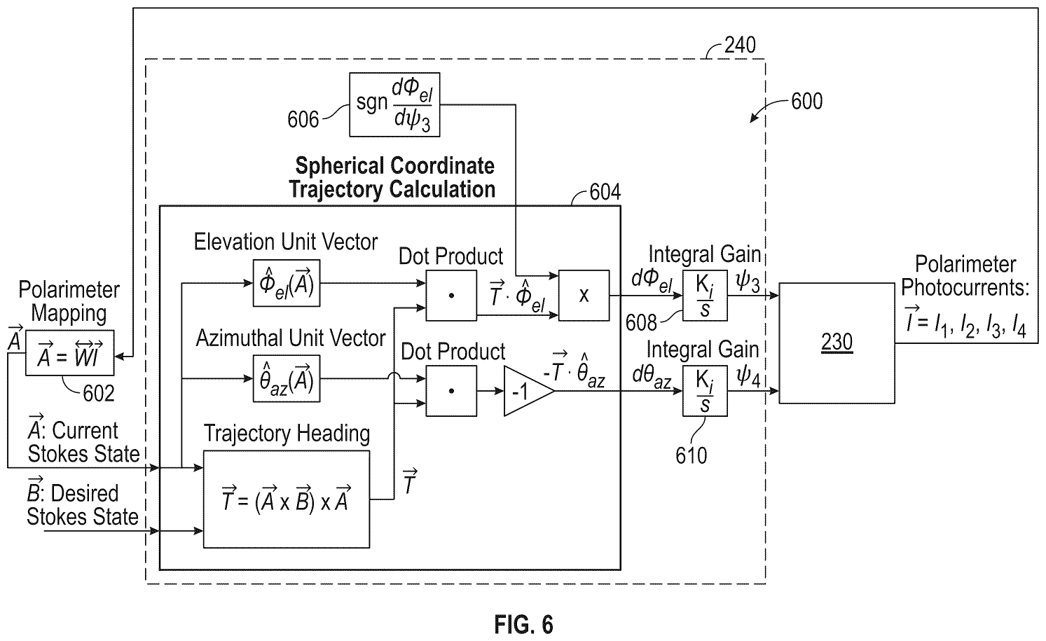

FIG. 6 depicts an exemplary control diagram for a polarization control system 600 suitable for implementation by the output polarization controller 240 to dynamically adjust actuation of the phase shifters 232, 234 of polarization shifting arrangement 230 to thereby adjust the relative magnitude and phase of the TE component signal and TM component signal to achieve a targeted state of polarization based on a difference between the relationship of the relative magnitudes and phases of the TE and TM component signals and a targeted relationship of the relative magnitudes and phases of the TE and TM component signals corresponding to a targeted state of polarization for the output optical signal exiting the polarization control circuit 200. The polarization control system 600 includes a polarimeter mapping component 602 that is configured to map or otherwise convert a vector of the measured photocurrents from the photodiodes 408, 412, 424, 426 of the integrated polarimeter 238, 400 (e.g., \vec{I}=I₁, I₂, I₃, I₄)) into a vector (\vec{A}) indicative of the currently measured Stokes state corresponding to the state of polarization of the output optical signal using a polarimeter matrix ( [symbol] ) for mapping the four polarimeter photocurrents into a three-dimensional Stokes state.

The polarization control system 600 includes a spherical coordinate trajectory calculation component 604 that is configurable to calculate or otherwise determine a trajectory heading vector indicative of the desired direction of change in Stokes space corresponding to traversing the Poincaré sphere along a great-circle path based on the relationship between the currently measured Stokes state vector and an input reference vector (\vec{B}) indicative of the targeted or desired Stokes state corresponding to the targeted state of polarization for the output optical signal. The trajectory heading vector is calculated as a cross product of the input Stokes state vectors in accordance with the equation \vec{T}=(\vec{A}×\vec{B})×\vec{A} and then projected onto elevation and azumithal unit vectors derived from the current Stokes state by taking the dot product, resulting in elevation and azimuthal component vectors indicative of the amount of phase adjustment or actuation for the respective phase shifters 232, 234 to achieve the targeted polarization. In a similar manner as described above in the context of the signal conditioning control system 500, because the input polarization state is unknown, and due to an artifact of spherical coordinates, it is unknown whether a positive increase in the setpoint of the first phase shifter 232 will increase or decrease the elevation component, and therefore, the polarization control system 600 includes a directional difference determination component 606 that calculates, determines or otherwise outputs an indication of whether the derivative or rate of change of the elevation component is in the correct direction. The outputs of the spherical coordinate trajectory calculation component 604 correspond to the derivative or rate of adjustment to the respective phase setpoints of the respective phase shifters 232, 234, and the respective phase adjustment rates are input to respective integral gain component 608, 610 that provide respective outputs indicative of the phase adjustments or setpoints to be utilized by the output polarization controller 240 to operate the phase shifters 232, 234 of the polarization shifting arrangement 230.

Still referring to FIG. 6, in practice, the polarimeter matrix ( [symbol] ) may be derived via numerical optimization to account for nonidealities such as crosstalk in wavelength crossings, polarization crosstalk in the input polarization splitting arrangement 202 and/or the output polarization combining arrangement 250, and wavelength dependence of the phase delay that could otherwise impair theoretical or analytical solutions. The polarimeter matrix can be derived by collecting a dataset of measured polarimeter photocurrents in which the signal conditioning arrangement achieves balanced TE and TM output powers, and then sweeping the phase shifters 232, 234 across a wide range two-dimensionally, resulting in full coverage of the possible output polarization states, from which the elements of the polarimeter matrix ( [symbol] ) can be tuned or otherwise derived to maximize or optimize the sphericity of the dataset, for example, by using principal component analysis (PCA) on the measured Stokes state vector over time (\vec{A(t)}) to obtain the “explained variance” of each principal component vector and maximizing the product of the explained variance along three-dimensions (since a spherical dataset should have equal explained variance along its three principal components), thereby maximizing sphericity achieved by the polarimeter matrix ( [symbol] ). Such numerical optimization can be performed using any number of different algorithms or techniques which are not germane to this disclosure, such as, for example, the Nelder-Mead Simplex.

Referring again to FIGS. 1-2 with continued reference to FIGS. 3-6, in exemplary implementations, since the PIC 100 is fabricated or otherwise implemented on a semiconductor substrate, the phase shifters 212, 214, 232, 234 are realized as thermo-optic phase shifters to avoid the parasitic amplitude modulation that comes with carrier injection in p-n-junction shifters. Additionally, for optical signals that may enter or exit the PIC 100 at an arbitrary polarization, a TE/TM edge coupler with low polarization-dependent loss is utilized to couple the input 204 and/or output 252 of the polarization control circuit 200 to a fiberoptic cable or the like. Furthermore, for the interferometers to have low wavelength dependence, parallel paths should be matched using meanders and bends to match optical path lengths, with an extra quarter wavelength of path length being introduced to the integrated polarimeter 238, 400 (e.g., phase delay component 422) to achieve the π/2 phase shift. Additionally, it should be appreciated that in practice, waveguides for the respective TE and TM optical paths or other optical signal paths may be crossed by coupling the optical signal into a different waveguide layer (e.g., overlying or underlying the initial waveguide layer) to avoid obstacles and achieve symmetrical phase shifts and losses, or alternatively, by utilizing a waveguide crossing component that allows optical signals to pass orthogonally to one another in the same silicon layer. In this regard, such a waveguide crossing component 430 may be utilized in the integrated polarimeter 238, 400 for better path matching and reduced footprint.

Referring to FIG. 1-6, exemplary implementations described herein provide polarization control circuitry 102, 200 including an integrated polarimeter 238, 400 suitable for fabrication on a semiconductor substrate and implemented in a PIC 100, where the state of polarization feedback measurements from the polarimeter 238, 400 allow the polarization control circuitry 102, 200 to manipulate the state of polarization of the output optical signal exiting the polarization control circuitry 102, 200 to any arbitrary targeted state of polarization. To facilitate arbitrary-to-arbitrary polarization control, the polarization control circuitry 102, 200 includes an input signal conditioning arrangement 210 that substantially balances the power of the TE and TM polarized components of the input optical signal (e.g., driving toward the circle in the plane S1=0 in Stokes space) to allow the polarization control circuitry 102, 200 to traverse the Poincaré sphere with great-circle trajectories from any input state of polarization to a targeted state of polarization for the output optical signal exiting the polarization control circuitry 102, 200. Once the TE and TM components are substantially balanced, the output polarization controller 240 operates the phase shifters 232, 234 of the polarization shifting arrangement 230 to traverse the Poincaré sphere along a great-circle trajectory (\vec{T}) to arrive at TE and TM signal components with relative magnitude and phase that achieve the targeted state of polarization of the recombined output optical signal at the output 252 of the polarization control circuitry 102, 200.

It should be noted that although the subject matter is described herein in the context of the polarization control circuitry 102, 200 providing a recombined output optical signal having a desired state of polarization, it should be noted that the polarization control circuitry 102, 200 can be implemented in an equivalent manner to demultiplex polarization-multiplexed signals. In such implementations, the output polarization combining arrangement 250 is omitted or otherwise absent from the polarization control circuitry 102, 200, with the separate TE and TM polarized component signals being output from the polarization control circuitry 102, 200 or otherwise maintained separately. To support polarization demultiplexing of superimposed signals, the correlation between the constituent TE and TM polarized component signals may be measured and then utilized to actuate or otherwise operate the phase shifters 232, 234 of the polarization shifting arrangement 230 to minimize the correlation between the TE and TM polarized component signals, implying successful separation. In such implementations, the integrated polarimeter 238, 400 and the polarization control system 600 may be absent from the polarization control circuitry 102, 200 and in lieu of components and corresponding control systems configurable to measure the correlation between the constituent TE and TM polarized component signals and operate the phase shifters 232, 234 to minimize the correlation.

For the sake of brevity, conventional techniques related to fiber optics, polarization, multiplexing and/or demultiplexing, semiconductor device fabrication, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A photonic integrated circuit (PIC) comprising:
an input polarization splitting arrangement to split an input optical signal into a first portion at a first output and a second portion at a second output, wherein the first portion represents a first polarization orthogonal to a second polarization of the second portion;
a signal conditioning arrangement coupled to the first output and the second output of the input polarization splitting arrangement to provide a first signal corresponding to the first portion of the input optical signal and a second signal corresponding to the second portion of the input optical signal, wherein the signal conditioning arrangement is configurable to balance a first magnitude of the first signal and a second magnitude of the second signal;
a polarization shifting arrangement coupled to the signal conditioning arrangement to provide a first adjusted signal and a second adjusted signal based on the first signal, the second signal and a difference between a first relationship between the first signal and the second signal and a targeted relationship corresponding to a targeted state of polarization; and
an output polarization combining arrangement coupled to the polarization shifting arrangement and configured to provide an output optical signal comprising a combination of the first adjusted signal and the second adjusted signal.

2. The PIC of claim 1, wherein the output optical signal has the targeted state of polarization.

3. The PIC of claim 1, wherein the polarization shifting arrangement is configurable to adjust at least one of a first phase and the first magnitude of the first signal based on the difference between a relationship between the at least one of the first phase and the first magnitude of the first signal and at least one of a second phase and the second magnitude of the second signal and the targeted relationship to obtain the first adjusted signal having the targeted relationship to the second adjusted signal.

4. The PIC of claim 1, further comprising:
a first component to provide a first measurement indicative of the first magnitude of the first signal of the signal conditioning arrangement; and
a second component to provide a second measurement indicative of the second magnitude of the second signal of the signal conditioning arrangement, wherein the signal conditioning arrangement comprises one or more phase shifters operable to influence a phase of at least one of the first signal and the second signal to interferometrically regulate the first magnitude of the first signal to the second magnitude based on a relationship between the first measurement and the second measurement.

5. The PIC of claim 4, wherein the signal conditioning arrangement comprises a coupler to provide a first intermediate signal based at least in part on the first portion of the input optical signal and the second portion of the input optical signal and a second intermediate signal based at least in part on the first portion of the input optical signal and the second portion of the input optical signal, wherein:
the first component is configured to provide the first measurement based on the first intermediate signal;
the second component is configured to provide the second measurement based on the second intermediate signal; and
the one or more phase shifters comprise a first phase shifter coupled to the coupler to influence magnitude and phase of the first intermediate signal, resulting in the first signal.

6. The PIC of claim 4, wherein the first component comprises a first photodiode optically coupled to the first signal of the signal conditioning arrangement and the second component comprises a second photodiode optically coupled to the second signal of the signal conditioning arrangement.

7. The PIC of claim 4, wherein an input conditioning controller is coupled to the first component, the second component, and the one or more phase shifters, wherein the input conditioning controller is configurable to actuate the one or more phase shifters based on a second difference between the first measurement and the second measurement.

8. The PIC of claim 1, further comprising a polarimeter to provide a plurality of measurements indicative of an adjusted magnitude and phase relationship between the first signal and the second signal, wherein the polarization shifting arrangement is configurable to adjust a first phase of the first signal based on a second difference between a first measurement indicative of an adjusted relationship and the targeted relationship to obtain the first adjusted signal having the targeted relationship to the second adjusted signal.

9. The PIC of claim 8, wherein the polarization shifting arrangement comprises one or more phase shifters operable to adjust the first phase of the first signal to obtain the first adjusted signal.

10. The PIC of claim 9, wherein the polarization shifting arrangement comprises:
a 50/50 coupler;
a first phase shifter coupled between the signal conditioning arrangement and the 50/50 coupler to adjust the first phase of the first signal input to the 50/50 coupler, wherein the 50/50 coupler is configurable to provide a first intermediate signal based at least in part on the first signal and the second signal and the second adjusted signal based at least in part on the first signal and the second signal; and
a second phase shifter coupled between the 50/50 coupler and the output polarization combining arrangement to adjust a third phase of the first intermediate signal exiting the 50/50 coupler, resulting in the first adjusted signal, wherein the output polarization combining arrangement is configurable to combine the first adjusted signal and the second adjusted signal to obtain the output optical signal.

11. A polarization control system comprising:
a first polarization splitter-rotator to receive an input optical signal and split the input optical signal into a first input signal representing a transverse electric polarization of the input optical signal and a second input signal representing a transverse magnetic polarization of the input optical signal orthogonal to the transverse electric polarization;
a signal conditioning arrangement coupled to the first polarization splitter-rotator configurable to receive the first input signal and the second input signal and generate a first power balanced signal corresponding to the transverse electric polarization of the input optical signal and a second power balanced signal corresponding to the transverse magnetic polarization of the input optical signal by regulating a first magnitude of the first input signal to a second magnitude of the second input signal;
a polarization shifting arrangement coupled to the signal conditioning arrangement to provide a first adjusted signal and a second adjusted signal based on the first power balanced signal, the second power balanced signal and a difference between a relationship between the first power balanced signal and the second power balanced signal and a targeted state of polarization; and
an output polarization combiner configurable to provide an output optical signal having the targeted state of polarization, wherein the output optical signal comprises a combination of the first adjusted signal and the second adjusted signal.

12. The polarization control system of claim 11, further comprising:
a first photodiode to provide a first measurement indicative of a third magnitude of the first power balanced signal of the signal conditioning arrangement; and
a second photodiode to provide a second measurement indicative of a fourth magnitude of the second power balanced signal of the signal conditioning arrangement, wherein the signal conditioning arrangement comprises one or more phase shifters operable to influence a phase of at least one of the first input signal and the second input signal to interferometrically obtain the first power balanced signal and the second power balanced signal.

13. The polarization control system of claim 12, wherein the signal conditioning arrangement comprises a 50/50 coupler to receive the first input signal and the second input signal and provide a first intermediate signal and the second power balanced signal based at least in part on the first input signal and the second input signal, wherein the one or more phase shifters comprise a first phase shifter coupled to the 50/50 coupler to adjust the phase of the first intermediate signal to interferometrically obtain the first power balanced signal.

14. The polarization control system of claim 12, further comprising an input conditioning controller is coupled to the first photodiode, the second photodiode, and the one or more phase shifters, wherein the input conditioning controller is configurable to actuate the one or more phase shifters based on a second difference between the first measurement and the second measurement.

15. The polarization control system of claim 11, further comprising a polarimeter to provide measurements indicative of respective magnitudes and phases of the first adjusted signal and the second adjusted signal, wherein the polarization shifting arrangement is configurable to adjust relative magnitude and phase of the first power balanced signal and the second power balanced signal to obtain the first adjusted signal and the second adjusted signal corresponding to the targeted state of polarization.

16. The polarization control system of claim 15, wherein the polarization shifting arrangement comprises one or more phase shifters operable to adjust the relative magnitude and phase of the of the first power balanced signal and the second power balanced signal.

17. The polarization control system of claim 16, wherein the polarization shifting arrangement comprises:
a 50/50 coupler;
a first phase shifter coupled between the signal conditioning arrangement and the 50/50 coupler to adjust a first phase of the first power balanced signal input to the 50/50 coupler, wherein the 50/50 coupler is configurable to provide a first intermediate signal based at least in part on the first power balanced signal and the second power balanced signal and the second adjusted signal based at least in part on the first power balanced signal and the second power balanced signal; and
a second phase shifter coupled between the 50/50 coupler and the output polarization combiner to adjust a third phase of the first intermediate signal exiting the 50/50 coupler to obtain the first adjusted signal, wherein the output polarization combiner is configurable to combine the first adjusted signal and the second adjusted signal to obtain the output optical signal having the targeted state of polarization.

18. The polarization control system of claim 16, further comprising an electronic output polarization controller to receive feedback from the polarimeter and the one or more phase shifters and operate the one or more phase shifters, the phase offsets of which each correspond to an angular spherical coordinate in Stokes state such that an output polarization state is able to traverse the Poincaré sphere along a great circle path.

19. A method of transforming an input optical signal to an output optical signal having a targeted state of polarization using a photonic integrated circuit (PIC), the method comprising:
splitting the input optical signal into a first input signal representing a transverse electric polarization of the input optical signal and a second input signal representing a transverse magnetic polarization of the input optical signal orthogonal to the transverse electric polarization;
generating a first power balanced signal representing the transverse electric polarization and a second power balanced signal representing the transverse magnetic polarization based on the first input signal and the second input signal by adjusting a phase of at least one of the first input signal and the second input signal and interferometrically mixing them with a 50/50 coupler;
obtaining, using a polarimeter associated with the PIC, measurement data indicative of a state of polarization of a combination of a first output signal corresponding to the transverse electric polarization and a second output signal corresponding to the transverse magnetic polarization;
dynamically adjusting, based on the measurement data, the relative magnitude and phase of the first power balanced signal and the second power balanced signal to obtain the first output signal and the second output signal having a targeted magnitude and phase relationship based on a difference between the state of polarization and the targeted state of polarization; and
combining the first output signal and the second output signal into the output optical signal having the targeted state of polarization.

20. The method of claim 19, further comprising obtaining, via one or more photodiodes of the PIC, second measurement data indicative of respective magnitudes of the first power balanced signal and the second power balanced signal, wherein generating the first power balanced signal and the second power balanced signal comprises dynamically adjusting the phase of at least one of the first input signal and the second input signal based on the second measurement data.
